(19) United States
(12) Patent Application Publication
(10) Pub. No.: US 2018/0166714 A1
(43) Pub. Date: Jun. 14, 2018

(54) FUEL CELL SYSTEM

(71) Applicant: TOYOTA JIDOSHA KABUSHIKI KAISHA, Toyota-shi (JP)

(72) Inventors: Koichi KAMINO, Aichi-gun (JP); Nobutaka TESHIMA, Toyota-shi (JP)

(73) Assignee: TOYOTA JIDOSHA KABUSHIKI KAISHA, Toyota-shi (JP)

(21) Appl. No.: 15/834,579

(22) Filed: Dec. 7, 2017

(30) Foreign Application Priority Data
Dec. 12, 2016 (JP) 2016-240085

(51) Int. Cl. H01M 8/04119; H01M 8/1018; H01M 8/04746; H01M 8/04082

(52) U.S. Cl. CPC H01M 8/04164; H01M 8/1018; H01M 2250/20; H01M 8/04201; H01M 2008/1095; H01M 8/04753

(57) ABSTRACT

A fuel cell system includes: a fuel cell stack having a hydrogen supply port into which hydrogen flows; a hydrogen supply flow passage connected to the hydrogen supply port; and an injector connected to the hydrogen supply flow passage so as to supply hydrogen to the fuel cell stack through the hydrogen supply flow passage, and a hydrogen outlet of the injector connected to the hydrogen supply flow passage is disposed more upward in a gravity direction than the hydrogen supply port of the fuel cell stack.

### INCORPORATION BY REFERENCE

The disclosure of Japanese Patent Application No. 2016-240085 filed on Dec. 12, 2016 including the specification, drawings and abstract is incorporated herein by reference in its entirety.

### BACKGROUND

### 1. Technical Field

The present disclosure relates to a fuel cell system.

### 2. Description of Related Art

Japanese Unexamined Patent Application Publication No. 2008-16402 (JP 2008-16402 A) discloses a fuel cell system equipped with an injector. In this fuel cell system, hydrogen is supplied from a hydrogen tank via an injector to a fuel cell stack.

### SUMMARY

Due to a positional relation between a hydrogen outlet of the injector and a hydrogen supply port of the fuel cell stack, generated water stagnates in a flow passage, so that the flow passage is blocked up, or the generated water flows backward from the fuel cell stack to the injector in some cases. Stagnating or backward flow of the generated water might cause deterioration of a power generation performance or freezing. Hence, it has been desired to provide a technology capable of suppressing backward flow of the generated water to the injector or stagnation of the generated water.

The present disclosure can be implemented as the following aspects.

(1) According to one aspect of the present disclosure, provided is a fuel cell system. This fuel cell system includes: a fuel cell stack having a hydrogen supply port into which hydrogen flows; a hydrogen supply flow passage connected to the hydrogen supply port; an injector connected to the hydrogen supply flow passage so as to supply the hydrogen to the fuel cell stack through the hydrogen supply flow passage; and a hydrogen outlet of the injector connected to the hydrogen supply flow passage being disposed more upward in a gravity direction than the hydrogen supply port of the fuel cell stack. According to the fuel cell system of this aspect, since the hydrogen outlet of the injector is disposed more upward than the hydrogen supply port of the fuel cell stack, it is possible to suppress backward flow of the generated water to the injector or stagnation of the generated water in the hydrogen supply flow passage.

(2) In the fuel cell system of the above aspect, the injector may be located more upward in the gravity direction than the fuel cell stack. According to the fuel cell system of this aspect, in the case in which the fuel cell system is installed in the vehicle, the injector is disposed at an upper position of engine compartment, to thereby suppress the injector from sinking in the water. Accordingly, it is possible to enhance the water-proof property of the injector.

(3) In the fuel cell system of the above aspect, the hydrogen outlet may be disposed at a position more downward than or equal to a hydrogen inlet of the injector in the gravity direction. According to this fuel cell system, even in the case in which condensation is generated on the pipe of the hydrogen supply flow passage connected to the injector, it is possible to prevent dew condensation water from dropping toward the injector.

The present disclosure can be implemented by various aspects, and for example, the present disclosure can be implemented by an aspect of an electric power generator including a fuel cell system or an aspect of a vehicle including a fuel cell system, etc.

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1 is an explanatory view showing a schematic configuration of a fuel cell system; and

FIG. 2 is an explanatory view showing a positional relation between a fuel cell stack and an injector.

### DETAILED DESCRIPTION OF EMBODIMENTS

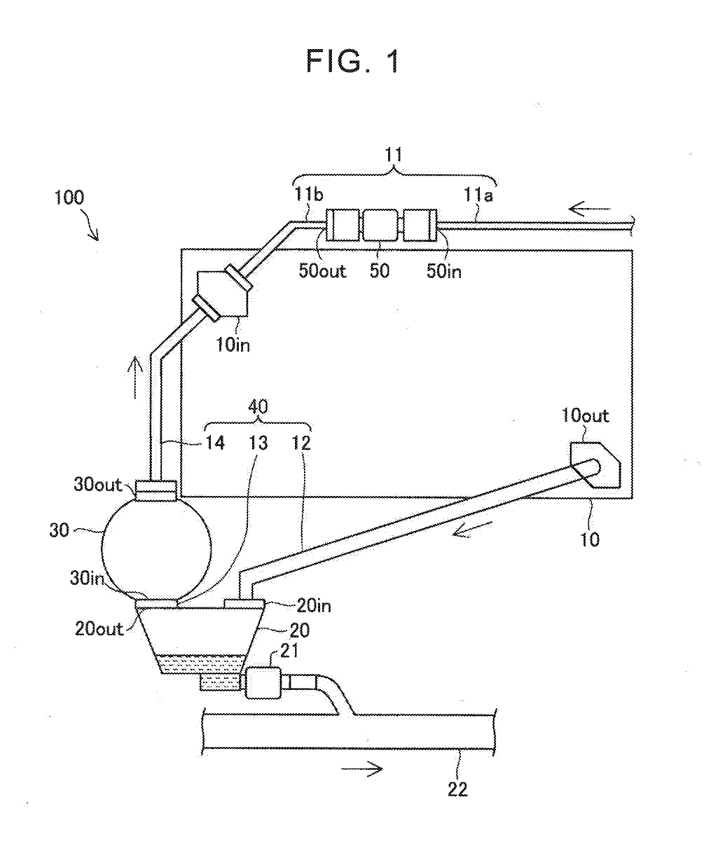

FIG. 1 is an explanatory view showing a schematic configuration of a fuel cell system 100 in one embodiment of the present disclosure. The fuel cell system 100 includes a fuel cell stack 10, a gas-liquid separator 20, a hydrogen pump 30, a hydrogen circulating flow passage 40, and an injector 50. The fuel cell system 100 of the present embodiment is installed in a fuel cell vehicle, for example.

The fuel cell stack 10 is a polymer electrolyte fuel cell, is supplied with hydrogen gas from the injector 50, and generates electric power by receiving air from an air supply system (not illustrated). Hereinafter, in a hydrogen supply pipe 11, a pipe located more upstream than the injector 50 is referred to as a hydrogen supply pipe 11a, a pipe located more downstream than the injector 50 is referred to as a hydrogen supply pipe 11b. The fuel cell stack 10 includes a hydrogen supply port 10in connected to the hydrogen supply pipe 11b, a hydrogen discharge port 10out discharging hydrogen-off gas into a first hydrogen pipe 12. The hydrogen supply pipe 11b is also referred to as a hydrogen supply flow passage.

The injector 50 is an on-off valve of an electromagnetic drive type whose valve body is electromagnetically driven depending on the driving period or the valve opening time that are defined by a control unit (not illustrated). The injector 50 includes a hydrogen inlet 50in into which the hydrogen flows from a hydrogen tank (not illustrated) through the hydrogen supply pipe 11a, and a hydrogen outlet 50out from which the hydrogen is discharged to the hydrogen supply pipe 11b.

The hydrogen supply pipe 11b is arranged in a manner as to be partially inclined from the hydrogen outlet 50out toward the hydrogen supply port 10in in the vertical direction or in the downward direction. The hydrogen supply pipe 11b is formed to have no part below the hydrogen supply port 10in.

The hydrogen circulating flow passage 40 is connected to the hydrogen supply port 10in and the hydrogen discharge port 10out of the fuel cell stack 10, and is composed of the first hydrogen pipe 12, the second hydrogen pipe 13, and a third hydrogen pipe 14. The hydrogen circulating flow passage 40 is a flow passage used for circulating the hydrogen-off gas of the fuel cell stack 10 through the fuel cell stack 10. The hydrogen circulating flow passage 40 is provided with the gas-liquid separator 20 and a hydrogen pump 30 that are a mechanism assisting the circulation of the hydrogen, as a circulation-system auxiliary machine.

The first hydrogen pipe 12 is a pipe connecting the hydrogen discharge port 10out of the fuel cell stack 10 to the gas-liquid separator 20. The first hydrogen pipe 12 conducts the hydrogen gas having not been used for power generation reaction and the hydrogen-off gas containing impurities such as nitrogen gas and generated water to the gas-liquid separator 20.

The gas-liquid separator 20 is connected between the first hydrogen pipe 12 and the second hydrogen pipe 13 of the hydrogen circulating flow passage 40. The gas-liquid separator 20 includes a gas-liquid inlet 20in to which the first hydrogen pipe 12 is connected and the hydrogen-off gas flows in, and a gas-liquid outlet 20out to which a second hydrogen pipe 13 is connected, the gas-liquid outlet 20out discharging the hydrogen. The gas-liquid separator 20 separates the generated water from the hydrogen-off gas having flowed in from the hydrogen discharge port 10out of the fuel cell stack 10, and stores the generated water therein. A vent-drain valve 21 is provided at a lower part of the gas-liquid separator 20.

The vent-drain valve 21 is an electromagnetic valve that drains the generated water stored in the gas-liquid separator 20 and discharges the hydrogen-off gas in the gas-liquid separator 20. During operation of the fuel cell system 100, the vent-drain valve 21 is normally closed, and is configured to open and close in response to a control signal from the control unit (not illustrated). In the present embodiment, the vent-drain valve 21 is connected to a hydrogen-off gas pipe 22 so as to discharge the generated water and the hydrogen-off gas that are discharged by the vent-drain valve 21 through the hydrogen-off gas pipe 22 to the outside.

The second hydrogen pipe 13 is a pipe connecting the gas-liquid outlet 20out of the gas-liquid separator 20 to the hydrogen pump 30. The second hydrogen pipe 13 conducts the hydrogen-off gas separated from the generated water by the gas-liquid separator 20 to the hydrogen pump 30.

The hydrogen pump 30 is connected between the second hydrogen pipe 13 and the third hydrogen pipe 14 of the hydrogen circulating flow passage 40. The hydrogen pump 30 is driven in response to a control signal from the control unit (not illustrated). The hydrogen pump 30 is a pump that feeds the hydrogen-off gas flowed from the hydrogen discharge port 10out of the fuel cell stack 10 to the hydrogen supply port 10in. More specifically, the hydrogen pump 30 feeds the hydrogen-off gas separated from the generated water by the gas-liquid separator 20 to the third hydrogen pipe 14. The hydrogen pump 30 includes a pump inlet 30in into which the hydrogen-off gas flows, and a pump outlet 30out from which the hydrogen-off gas flows out to the third hydrogen pipe 14.

The third hydrogen pipe 14 is a pipe connecting the pump outlet 30out of the hydrogen pump 30 to the hydrogen supply port 10in of the fuel cell stack 10. The third hydrogen pipe 14 conducts the hydrogen-off gas fed out by the hydrogen pump 30 to the fuel cell stack 10.

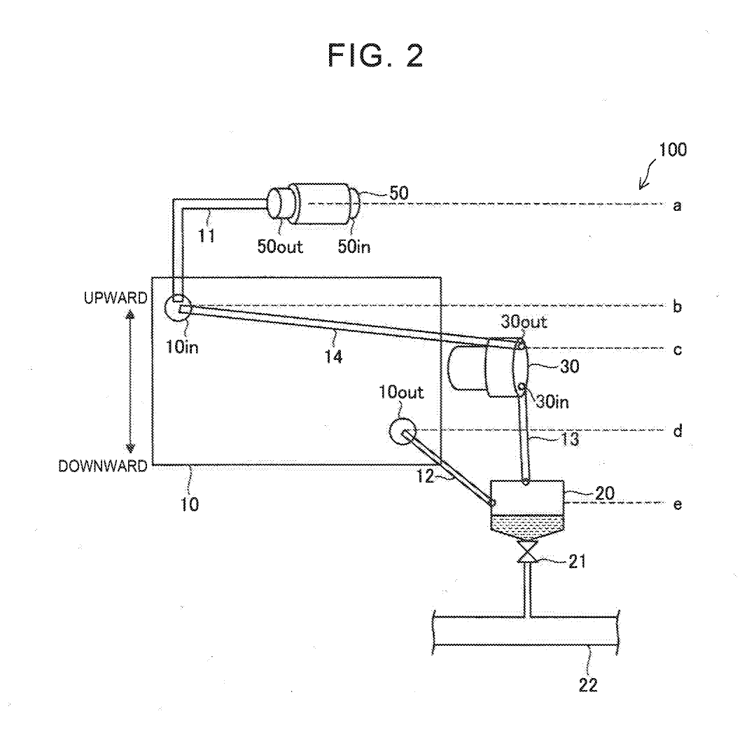

FIG. 2 is an explanatory view showing a positional relation between the fuel cell stack 10 and the injector 50. The lower direction in FIG. 2 indicates a lower direction in the gravity direction. The positions a, b indicate respective positions in the gravity direction. The position a of the hydrogen outlet 50out of the injector 50 is located more upward than the position b of the hydrogen supply port 10in.

In the present embodiment, the position a and the position b are located more upward than a position c of the pump outlet 30out and a position e of the gas-liquid separator 20. The position b of the hydrogen supply port 10in is located more upward than a position d of the hydrogen discharge port 10out.

According to the above-described fuel cell system 100 of the present embodiment, the hydrogen outlet 50out of the injector 50 is disposed more upward than the hydrogen supply port 10in of the fuel cell stack 10; therefore, it is possible to suppress backward flow of the generated water to the injector 50 or stagnation of the generated water in the hydrogen supply pipe 11b, for example, in the case in which the vehicle including the fuel cell system 100 is inclined, or during an intermittent operation of supplying the hydrogen not using the injector 50 but using the hydrogen pump 30. As a result, it is possible to suppress corrosion or freezing of the injector 50 resulting from the backward flow of the generated water, for example.

In the above embodiment, the injector 50 is preferably disposed at an upper position in the fuel cell stack 10. In such an arrangement, in the case in which the fuel cell system 100 is installed in the vehicle, the injector 50 is installed at an upper position in the engine compartment, and thus it is possible to suppress the injector 50 from sinking in the water. Hence, it is unnecessary to cover the entire injector 50 with the cover, or to additionally provide a seal member to prevent the water from entering the inside thereof from the outside, etc. As a result, production cost of the fuel cell system 100 can be reduced.

In addition, it is preferable to define the positional relation between the hydrogen inlet 50in and the hydrogen outlet 50out such that the hydrogen outlet 50out is located at a position more downward than or equal to the hydrogen inlet 50in. If the hydrogen outlet 50out is not located more upward than the hydrogen inlet 50in, it is possible to prevent dew condensation water from dropping toward the injector 50 even when condensation is generated on the hydrogen supply pipe 11b.

The disclosure is not limited to the above embodiment, but may be implemented by various configurations without departing from the scope of the disclosure. For example, the technical features of the embodiment corresponding to the technical features of the respective aspects described in Summary may be replaced or combined appropriately, in order to achieve part or all of the advantageous effects described above. Any of the technical features may be omitted appropriately unless the technical feature is described as essential in the present specification.

What is claimed is:

1. A fuel cell system comprising:
a fuel cell stack including a hydrogen supply port into which hydrogen flows;
a hydrogen supply flow passage connected to the hydrogen supply port;
an injector connected to the hydrogen supply flow passage so as to supply the hydrogen to the fuel cell stack through the hydrogen supply flow passage; and
a hydrogen outlet of the injector connected to the hydrogen supply flow passage being disposed more upward in a gravity direction than the hydrogen supply port of the fuel cell stack.

2. The fuel cell system according to claim 1, wherein
the injector is located more upward in the gravity direction than the fuel cell stack.

3. The fuel cell system according to claim 1, wherein
the hydrogen outlet is disposed at a position more downward than or equal to a hydrogen inlet of the injector in the gravity direction.
